(19) United States
(12) Patent Application Publication
(10) Pub. No.: US 2008/0127843 A1
(43) Pub. Date: Jun. 5, 2008

(54) PAD PRINTING SYSTEM WITH PAD BELT

(76) Inventors: Christopher Schaafsma, Wheaton, IL (US); Gregory Sherf, Roscoe, IL (US); Tracy Kucaba, South Elegin, IL (US)

Correspondence Address: CARDINAL LAW GROUP, Suite 2000, 1603 Orrington Avenue, Evanston, IL, 60201, US

(21) Appl. No.: 11/927,226

(22) Filed: Oct. 29, 2007

Related U.S. Application Data
(60) Provisional application No. 60/867,967, filed on Nov. 30, 2006.

(51) Int. Cl. B41F 1/16

(52) U.S. Cl. 101/163; 101/170

(57) ABSTRACT

A pad printing system for applying an image to a print object includes a cliché device capable of presenting a raised ink image and a conveyer belt. A plurality of pads attached to the conveyer belt. The conveyer belt is operable to move the pads into contact with the cliché device to pick up the raised ink image, and then to move the pads into contact with the print object to transfer the image to the print object.

### RELATED APPLICATIONS

This application claims the benefit of, and priority to, U.S. Provisional Patent Application 60/867,967, filed Nov. 30, 2006, the entirety of which is hereby incorporated by reference.

### TECHNICAL FIELD OF THE INVENTION

The present invention relates generally to printing and in particular to pad printing.

### BACKGROUND OF THE INVENTION

Pad printing has been used for many years to apply an image to a product. Pad printing is especially prevalent in applications for applying images to rounded and specially contoured products, such as syringes and golf balls.

FIG. 1a through FIG. 1e illustrate a standard pad printing system cycle, in accordance with the prior art. The standard pad printing system is a reciprocating cliché press 105 and includes a cliché device, such as cliché plate 110, a pad 120 and an ink cup 130. FIG. 1a illustrates the cliché plate, pad and ink cup in the starting position. In FIG. 1b, the cliché plate moves back under the ink cup receiving a coating of ink. The cliché plate moves forward, FIG. 1c, and the ink cup doctors the cliché plate as the pad moves onto the inked and doctored cliché plate picking up the ink from the cliché plate. The pad moves up, FIG. 1d, as the cliché plate moves back receiving another coating of ink. The pad moves down, FIG. 1e, and contacts a print object 140, thereby transferring the ink to the print object. The amount of time required to complete the cycle is the cycle speed. The multiple steps involved in the standard pad printing process limit the cycle speed of the pad printing system. Various modifications and refinements have been made to the standard pad printing system, such as keeping the cliché plate fixed and moving the ink cup back and forth over the cliché plate, or moving the pad from cliché plate to print object and back.

FIG. 2 illustrates a gravure wheel pad printing system in accordance with the prior art at 200. The gravure wheel system 205 includes an ink delivery unit 210, pad 120, and cliché device 215. Both pad 120 and cliché device 215 are cylindrical in a gravure wheel system. The cylindrical pad 120 is effective for printing on a cylindrical print object 220 and is sometimes used to print a spherical print object, such as a golf ball. More complex three dimensional shapes are difficult to print using gravure wheel system 205, since the flexibility of pad 120 is limited by its cylindrical shape.

Cliché device 215 is inked and doctored in ink delivery unit 210, by spinning cliché device 215 in an open ink well 230 filled with ink 240 and wiping the cliché device with a doctor blade 250. Cliché device 215 transfers ink 240, in the form of an image, to the cylindrical pad 120. The cylindrical pad then transfers the ink a print object 220. In one example, a sealed ink cup is used in ink delivery unit 210.

The throughput of any pad printing system is the number of print objects that can be printed in a given period of time. The throughput of the standard pad printing system is limited by the cycle speed attainable with the reciprocating cliché system 105. In addition, the speed of the standard pad printing system affects the quality of the image transfer to the print object. A pad that moves too quickly will not transfer the image effectively, while a pad that moves too slowly allows effective transfer of the image but decreases the throughput of the pad printing system.

An advantage of the gravure wheel system as compared to a standard pad printing system is speed. In one example, using a 1 inch diameter cylinder, a gravure wheel system can print approximately 120,000 parts/hour. In contrast, a standard pad printing system printing the same parts, can print approximately 3000 parts/hour. The gravure wheel system is less effective when printing complex three dimensional shapes.

While the printing pad of a standard pad printing system is adapted to printing various shaped objects, the cylindrical shape of the printing pad used in the gravure wheel system limits the ability of the pad to conform to the print object.

Various modifications have been proposed for the gravure wheel system pad printing system, including a steel belt cliché described in U.S. Pat. No. 7,036,428 B2 granted to Chapman.

It is, therefore, desirable to provide a system for pad printing that would overcome the aforementioned and other disadvantages.

### SUMMARY OF THE INVENTION

One aspect of the invention provides a pad printing system, for applying an image to a print object, including a cliché device capable of presenting a raised ink image, a conveyer belt, and a plurality of pads attached to the conveyer belt; wherein the conveyer belt is operable to move the pads into contact with the cliché device to pick up the raised ink image, and then to move the pads into contact with the print object to transfer the raised ink image thereto.

Another aspect of the invention provides a method for pad printing including sequentially conveying a plurality of pads into contact with the a cliché device presenting a raised ink image, each of the pads being disposed on a conveyor belt, picking up the raised ink image on the plurality of pads, and transferring the raised ink image from the pads onto a print object.

A third aspect of the invention provides a pad printing system, for applying an image to a print object, including means for sequentially conveying a plurality of pads into contact with a cliché device presenting a raised ink image, means for picking up the raised ink image on the plurality of pads, and means for transferring the raised ink image from the pads onto a print object.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1a through FIG. 1e illustrate one example of a standard pad printing system cycle, in accordance with the prior art;

FIG. 2 illustrates one example of a gravure wheel pad printing system, in accordance with the prior art;

FIG. 3 illustrates a schematic representative of one example of a system for pad printing with a pad belt, in accordance with the invention; and

FIG. 4 illustrates a flowchart of one example of a method for pad printing with a pad belt, in accordance with the invention.

### DETAILED DESCRIPTION OF THE PRESENTLY PREFERRED EMBODIMENTS

FIG. 3 illustrates a schematic representative of one example of a system for pad printing with pad belt, in accordance with the invention at 300.

The pad printing system with pad belt 305 includes a gravure wheel type ink delivery unit 210. The ink delivery system transfers ink 240 to an image bearing cliché device 215. In one example, image bearing cliché device 215 is a cylindrical cliché. In another example, image bearing cliché device 215 is a cliché plate. Ink 240, in the form of the image, is transferred, sequentially, to a series of pads 310 mounted on a conveyer belt, such as pad belt 320. Pads 310 transfer ink 240 to a print object 330 such as a golf ball, as the print object is conveyed into contact with pads 310 on pad belt 320. Another print object, such as a handle that includes a complex three dimensional shape, can be printed using the pad printing system with pad belt 305. In one example, pads 310 are removable from pad belt 320 allowing inspection or replacement of each pad 310 individually.

Cliché device 215 and pad belt 320 move at different speeds, in a substantially non-reciprocal motion, wherein the cliché device and the pad belt rotate while remaining in a consistent position relative to each other. Ink is applied to the cliché device for each pad 310 on pad belt 320. The non-reciprocal motion includes the cliché device 215 spinning faster than pad belt 320. The rotational speed of cliché device 215 is proportional to the speed of pad belt 320. Furthermore, cliché device 215 spins at a speed approximately equal to the speed of pad belt 320 times the number of pads 310 on the pad belt 320. Additionally, cliché device 215 speed is timed to allow for space between pads 310 on pad belt 320. The increase in the speed of cliché device 215, provided by the pad printing system with pad belt, allows an increase in the throughput of the pad printing system without increasing the speed at which pads 310 move.

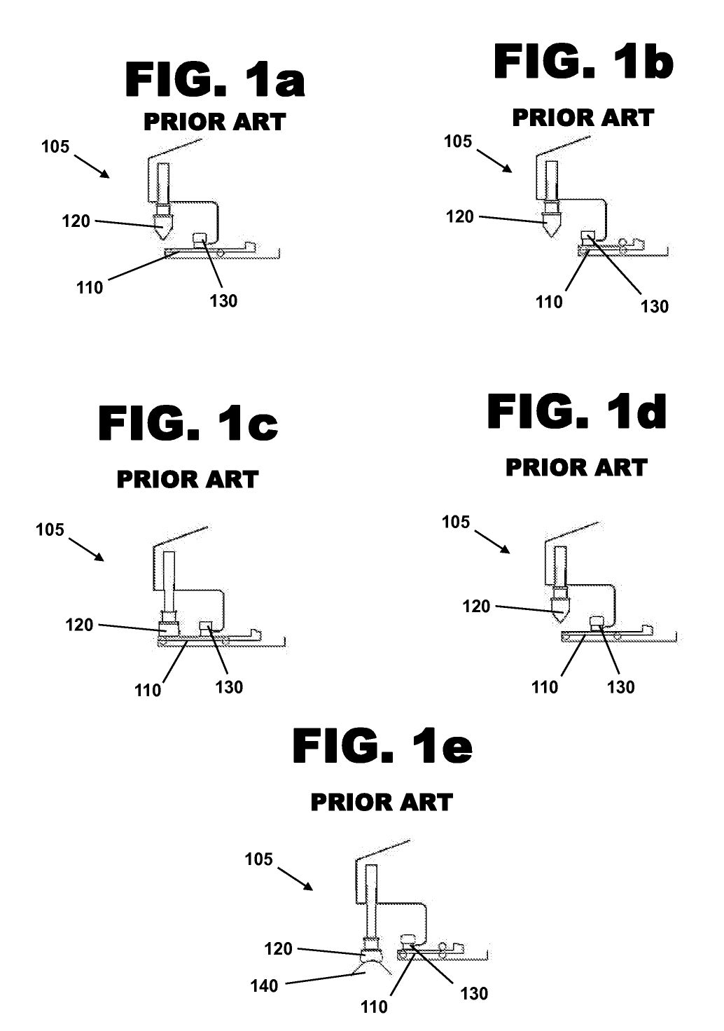

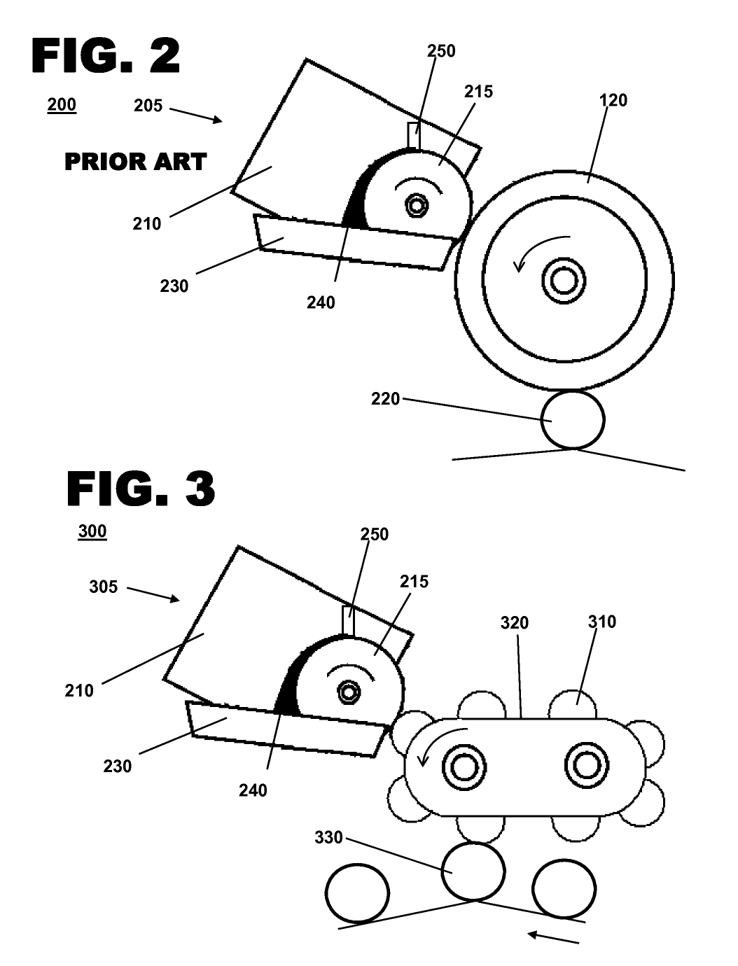

In one example, pad belt 320 is used with a standard pad printing system such as that shown in FIG. 1, having a reciprocating planar cliché plate. The cliché plate cycles back and forth and receives ink from the ink cup thereby presenting a raised ink image. Each printing pad on the pad belt sequentially comes into contact with the cliché device as it cycles back and forth. As the printing pad contacts the cliché plate, it picks up the raised ink image. The printing pad then moves along with the pad belt and transfers the raised ink image to a print object.

In each of the previous examples, the speeds of both the cliché device and the pad belt can be modified. The speed is modified to accomplish various objectives, such as bypassing a pad on the pad belt or adjusting a print quality of the system.

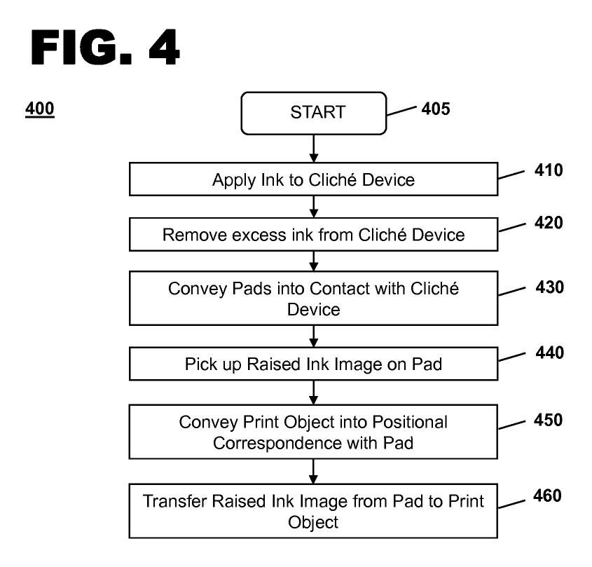

FIG. 4 illustrates a flowchart of one example of a method for pad printing with pad belt, in accordance with the invention at 400.

Ink is applied to a cliché device (block 410) and any excess ink is removed from the cliché plate (block 420). Excess ink is ink that is deposited on the cliché plate but is not located in the area corresponding to the image on the cliché device. A doctor blade is moved across the cliché device to remove the excess ink. The ink is applied and doctored in an ink delivery unit, such as an open well ink unit. The remaining ink produces a raised ink image on the cliché device.

A plurality of pads is conveyed into contact with the cliché device (block 430). The pads are conveyed on a conveyor belt, traveling in a loop. The speed of conveyance is set so that a pad contacts the image bearing cliché device after it is inked. The cliché device and the conveyor move in a non-reciprocal motion by which they maintain the same position relative to each other. In one example, the rotational speed of the cliché device is proportional to the number of pads on the conveyor belt and the speed of the conveyor belt is determined so that the cliché device is inked each time a pad contacts the cliché device. The drive system is geared to maintain a substantially constant proportional speed between the cliché device and the conveyor belt.

The raised ink image is picked up by each pad as it contacts the cliché device (block 440). Each pad, in succession, contacts the cliché device as ink is applied to and excess ink is removed from the cliché device.

Print objects are conveyed to the pad printing device in positional correspondence with the pads (block 450). In one example, the print object includes a complex three dimensional shape, such as a handle. In another example, the print object includes a flat profile, such as a glass plate. In another example, the print object includes an irregular surface, such as a golf ball. In a further example, the print object includes a cylindrical shape, such as a syringe. The image is transferred from the pads to the print objects (block 460). The print objects are conveyed adjacent the pads and pressed against the pads as they pass thereby transferring the ink from the pad to the print object.

In the disclosure, the words “a” or “an” are to be taken to include both the singular and the plural. Conversely, any reference to plural items shall, where appropriate, include the singular.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A pad printing system for applying an image to a print object, the system comprising:
a cliché device capable of presenting a raised ink image;
a conveyer belt; and
a plurality of pads attached to the conveyer belt; wherein the conveyer belt is operable to move the pads into contact with the cliché device to pick up the raised ink image, and then to move the pads into contact with the print object to transfer the raised ink image thereto.

2. The system of claim 1, wherein at least one of the pads is removably attached to the conveyor belt.

3. The system of claim 1, wherein the cliché device is substantially planar.

4. The system of claim 1, wherein the cliché device is substantially cylindrical.

5. The system of claim 4, wherein a rotational speed of the cliché device is proportional to a speed of the conveyor belt.

6. The system of claim 1, further comprising an ink delivery unit.

7. The system of claim 1, further comprising a print object conveying device, wherein the print object conveying device is operable to translate at least one print object into positional correspondence with the pads to effect ink transfer to the print object from a pad.

8. The system of claim 6, wherein the ink delivery unit comprises an open ink well.

9. The system of claim 6, wherein the ink delivery unit comprises a sealed ink cup.

10. A method for pad printing, the method comprising:
sequentially conveying a plurality of pads into contact with the a cliché device presenting a raised ink image, each of the pads being disposed on a conveyor belt;
picking up the raised ink image on the plurality of pads; and
transferring the raised ink image from the pads onto a print object.

11. The method of claim 10, further comprising:
applying a quantity of ink to the cliché device; and
removing a quantity of excess ink from the cliché device.

12. The method of claim 10, further comprising:
conveying at least one print object into positional correspondence with the pads to effect ink transfer to the print object from a pad.

13. A pad printing system for applying an image to a print object, the system comprising:
means for sequentially conveying a plurality of pads into contact with a cliché device presenting a raised ink image;
means for picking up the raised ink image on the plurality of pads; and
means for transferring the raised ink image from the pads onto a print object.

14. The system of claim 13, further comprising:
means for applying a quantity of ink to the cliché device; and
means for removing a quantity of excess ink from the cliché device.

15. The system of claim 13 further comprising:
means for conveying at least one print object into positional correspondence with the pads to effect ink transfer to the print object from a pad.
